(19) United States
(12) Patent Application Publication
(10) Pub. No.: US 2006/0025878 A1
(43) Pub. Date: Feb. 2, 2006

(54) Interior design using rapid prototyping

(76) Inventors: Bran Ferren, Beverly Hills, CA (US); Clarence T. Tegreene, Bellevue, WA (US)

Correspondence Address: SEARETE LLC;CLARENCE T. TEGREENE, 1756 - 114TH AVE., S.E., SUITE 110, BELLEVUE, WA, 98004, US

(21) Appl. No.: 10/909,132

(22) Filed: Jul. 30, 2004

(51) Int. Cl. G06F 19/00

(52) U.S. Cl. 700/98; 700/119

(57) ABSTRACT

A method for producing a model of an interior configuration of one or more three-dimensional objects within a three-dimensional interior space, including accepting interior space data representing at least a portion of the three-dimensional interior space; providing the interior space data to one or more rapid prototyping apparatuses to create an interior space item including a cavity, the cavity at least partially constituting a model of the three-dimensional interior space; accepting object data representing at least the one or more three-dimensional objects; and providing the object data to the one or more rapid prototyping apparatuses to create one or more object items, the one or more object items at least partially constituting models of the one or more three-dimensional objects. Other methods for producing such a model and an article are also disclosed.

### CROSS-REFERENCE TO RELATED APPLICATIONS

The present application is related to, claims the earliest available effective filing date(s) from (e.g., claims earliest available priority dates for other than provisional patent applications; claims benefits under 35 USC § 119(e) for provisional patent applications), and incorporates by reference in its entirety all subject matter of the following listed application(s); the present application also claims the earliest available effective filing date(s) from, and also incorporates by reference in its entirety all subject matter of any and all parent, grandparent, great-grandparent, etc. applications of the following listed application(s):

1. U.S. patent application entitled EMBEDDED IDENTIFIERS, naming Bran Ferren, Edward K. Y. Jung and Clarence T. Tegreene as inventors, filed 16 Mar. 2004 having U.S. patent application Ser. No. 10/802,106.

2. U.S. patent application entitled A SYSTEM FOR MAKING CUSTOM PROTOTYPES, naming Edward K. Y. Jung, Bran Ferren and Clarence T. Tegreene as inventors, filed 2 Jul. 2004 having U.S. patent application Ser. No. 10/884,760.

3. U.S. patent application entitled PERSONALIZED PROTOTYPING, naming Edward K. Y. Jung, Bran Ferren and Clarence T. Tegreene as inventors, filed 16 Jul. 2004 having U.S. patent application Ser. No. 10/892,974.

4. U.S. patent application entitled CUSTOM PROTOTYPING, naming Edward K. Y. Jung, Bran Ferren and Clarence T. Tegreene as inventors, filed 16 Jul. 2004 having U.S. patent application Ser. No. 10/892,755.

### TECHNICAL FIELD

The present application relates, in general, to creating models for interior design.

### SUMMARY

One embodiment, a method for producing a model of an interior configuration of one or more three-dimensional objects within a three-dimensional interior space, includes accepting one or more interior space input data sets, the one or more interior space input data sets including interior space data representing at least a portion of the three-dimensional interior space; providing the interior space data to one or more rapid prototyping apparatuses to create an interior space item including a cavity, the cavity at least partially constituting a model of the three-dimensional interior space; accepting one or more object input data sets, the one or more object input data sets including object data representing at least the one or more three-dimensional objects; and providing the object data to the one or more rapid prototyping apparatuses to create one or more object items, the one or more object items at least partially constituting models of the one or more three-dimensional objects. In addition to the foregoing, other method aspects are described in the claims, drawings, and text forming a part of the present application.

In one or more various aspects, related systems include but are not limited to circuitry and/or programming and/or electromechanical components for effecting the herein-referenced method aspects; the circuitry and/or programming and/or electro-mechanical components can be virtually any combination of hardware, software, firmware, and/or electromechanical components configured to effect the herein-referenced method aspects depending upon the design choices of the system designer in light of the teachings herein.

Another embodiment, an article includes an interior space item including a cavity, the cavity at least partially constituting a model of an interior space, the cavity shaped by one or more rapid prototyping apparatuses according to interior space data representing at least a portion of the interior space; and one or more object items, the one or more object items at least partially constituting models of one or more three-dimensional objects within the interior space, the one or more object items shaped by one or more rapid prototyping apparatuses according to object data representing the one or more three-dimensional objects, the one or more object items at least partially resident within the cavity. In addition to the foregoing, other article aspects are described in the claims, drawings, and text forming a part of the present application.

Another embodiment, a method for producing a model of an interior configuration of at least one three-dimensional object within a three-dimensional interior space, includes but is not limited to receiving interior space data for a rapid prototyping apparatus, the interior space data structured to create an interior space item including a cavity, the cavity at least partially constituting a model of the three-dimensional interior space; and receiving object data for the rapid prototyping apparatus, the object data structured to create at least one object item, the at least one object item at least partially constituting a model of the at least one three-dimensional object. In addition to the foregoing, other method aspects are described in the claims, drawings, and text forming a part of the present application.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer

Other embodiments are described in the detailed descriptions of the figures. In addition to the foregoing, various other method and/or system and/or article aspects are set forth and described in the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, inventive features, and advantages of the devices and/or processes described herein, as defined solely by the claims, will become apparent in the detailed description set forth herein.

### BRIEF DESCRIPTION OF THE FIGURES

FIG. 1 is a flow chart depicting an embodiment of the subject matter of the present application;

FIG. 2 is a flow chart depicting another embodiment of the subject matter of the present application;

FIG. 3 is a flow chart depicting another embodiment;

FIG. 4 is a flow chart depicting another embodiment;

FIG. 5 is a flow chart depicting another embodiment;

FIG. 6 is a flow chart depicting another embodiment;

FIG. 7 is a flow chart depicting another embodiment;

FIG. 8 is a flow chart depicting another embodiment;

FIG. 9 is a flow chart depicting another embodiment;

FIG. 10 is a flow chart depicting another embodiment;

FIG. 11 is a flow chart depicting another embodiment; and

FIG. 12 is a schematic diagram depicting another embodiment.

The use of the same symbols in different drawings typically indicates similar or identical items

### DETAILED DESCRIPTION

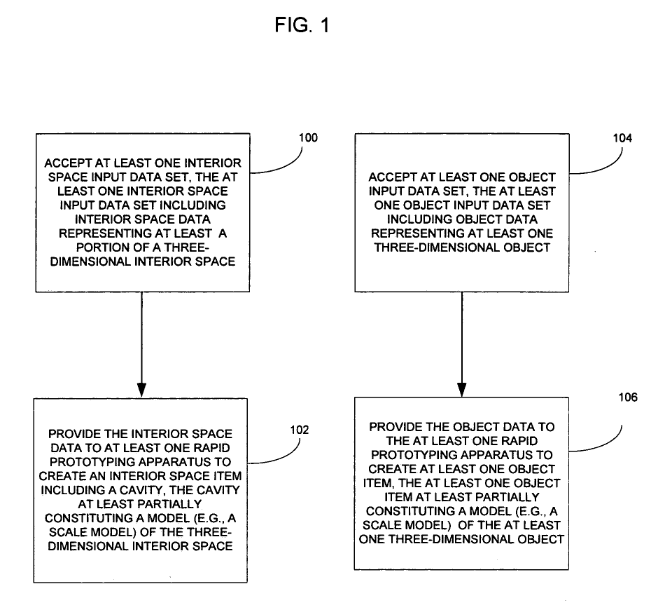

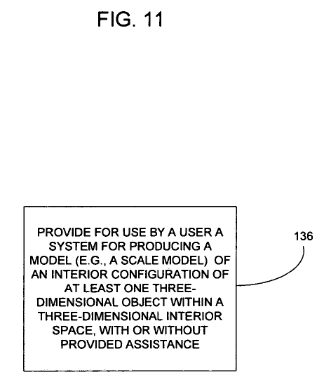

FIG. 1 shows an embodiment of the subject matter of the present application, a method for producing a model of an interior configuration of at least one three-dimensional object within a three-dimensional interior space, the method including accepting one or more interior space input data sets, the one or more interior space input data sets including interior space data representing at least a portion of the three-dimensional interior space (step 100); providing the interior space data to one or more rapid prototyping apparatuses to create an interior space item including a cavity, the cavity at least partially constituting a model of the three-dimensional interior space (step 102); accepting one or more object input data sets, the one or more object input data sets including object data representing at least the one or more three-dimensional objects (step 104); and providing the object data to the one or more rapid prototyping apparatuses to create one or more object items, the one or more object items at least partially constituting models of the one or more three-dimensional objects (step 106). In some implementations, at least a part of the model(s) are to scale, while in other implementations at least a part of the model(s) are not to scale. This embodiment may be used, for instance, by a user wishing to produce a model to aid visualization of one of more arrangements of objects in an interior space for the interior design of that interior space. (This embodiment may be implemented, e.g., using at least in part a suitably programmed and equipped computer system such as the one described herein and/or below with regard to FIG. 11.)

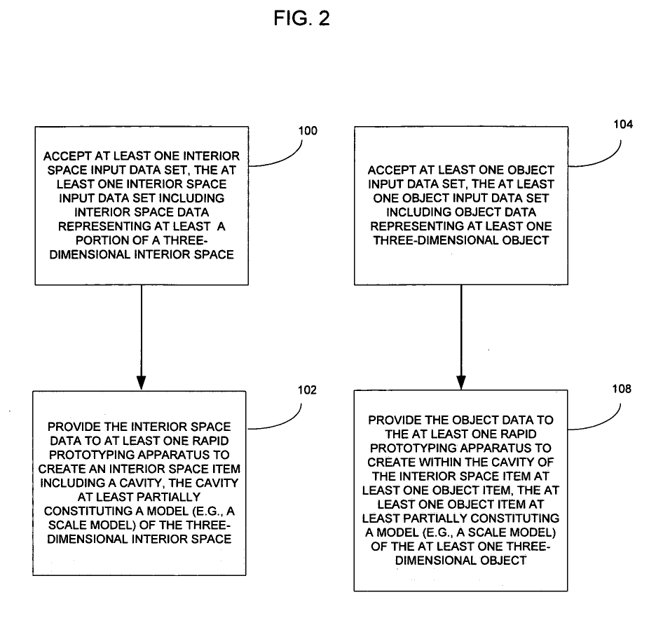

As shown in FIG. 2, another embodiment includes steps 100, 102 and 104, and in addition, step 108: providing the object data to the one or more rapid prototyping apparatuses to create one or more object items, the one or more object items at least partially constituting models of the one or more three-dimensional objects, for creating one or more object items within the cavity of the interior space item.

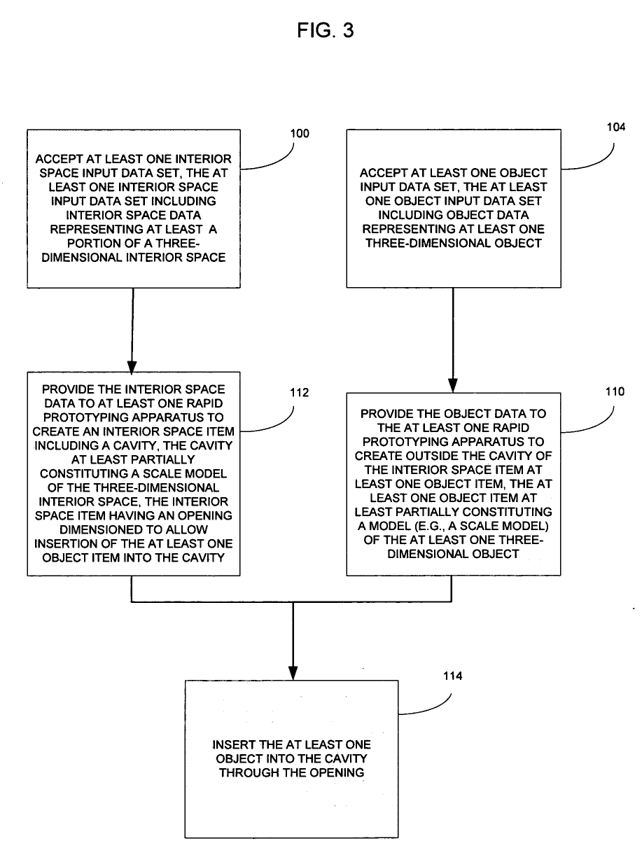

FIG. 3 shows another embodiment that includes steps 100 and 104 as described above, and the following steps: providing the object data to the one or more rapid prototyping apparatuses to create one or more object items, the one or more object items at least partially constituting models of the one or more three-dimensional objects to create the one or more object items outside the cavity of the interior space item (step 110); providing the interior space data to one or more rapid prototyping apparatuses to create an interior space item including a cavity, the cavity at least partially constituting a model of the three-dimensional interior space to create the interior space item having a opening into the cavity dimensioned to allow insertion of the at least one object item into the cavity (step 112); and inserting the one or more object items into the cavity through the opening (step 114).

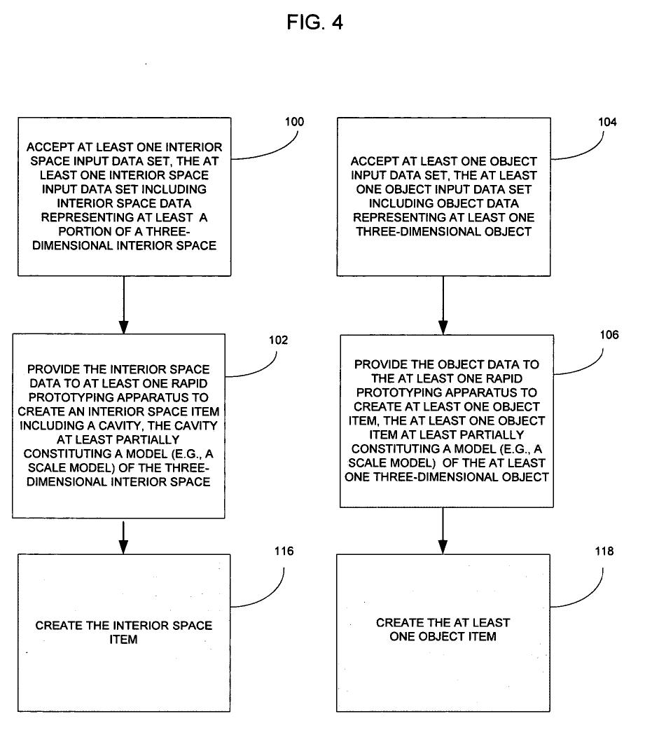

Another embodiment is shown in FIG. 4, which depicts steps 100, 102, 104 and 106 as described above, and the additional steps of creating the interior space item (step 116) and creating the one or more object items (step 118).

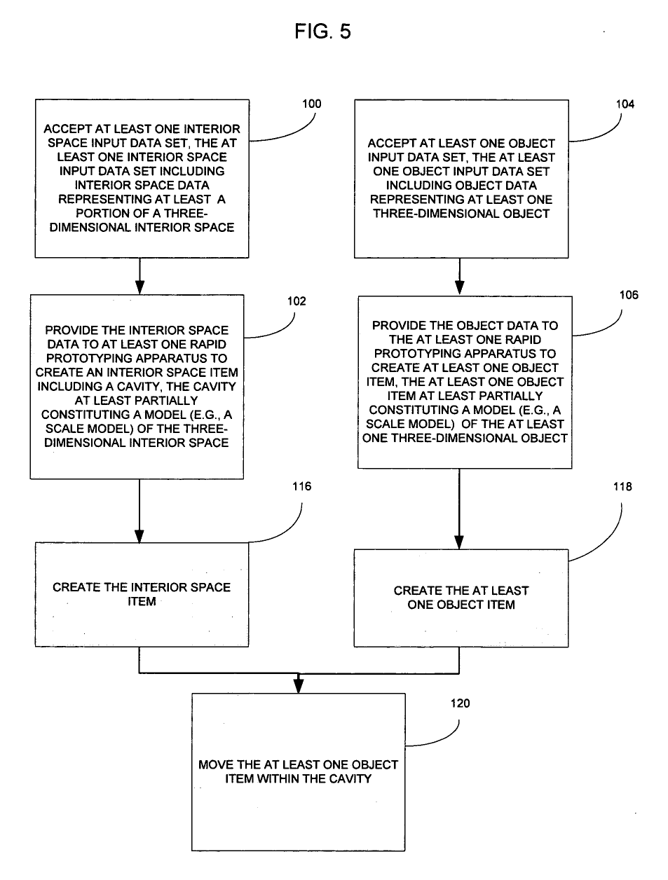

FIG. 5 shows another embodiment including steps 100, 102, 104, 106, 116 and 118 as described above, plus the additional step of moving the one or more object items within the cavity (step 120). The embodiment of FIG. 5 may permit a user to arrange the one or more object items within the cavity to aid in visualization of various arrangements. Where one or more of the object items and or the cavity are fabricated to scale, the items can aid a user in visualizing relationships between the items or items and the cavity.

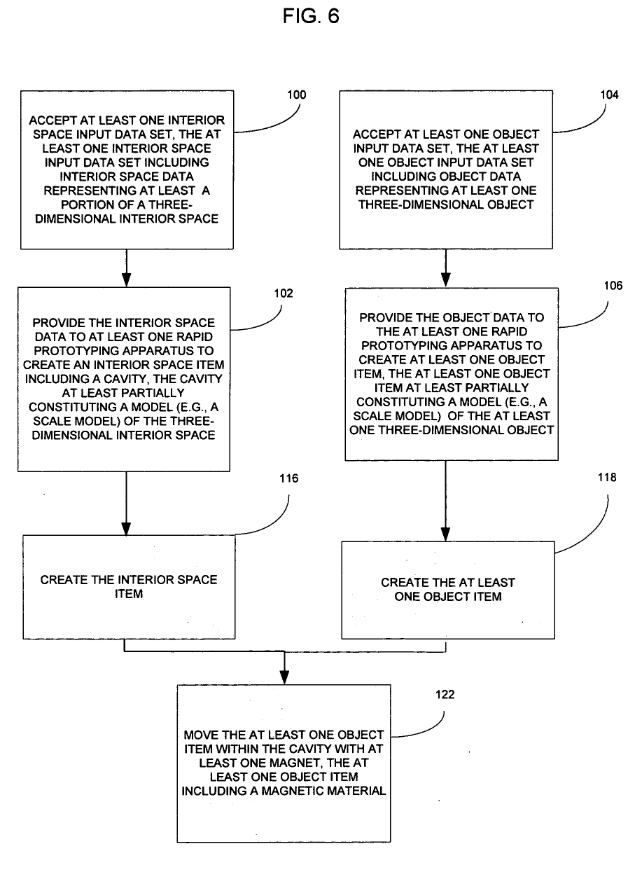

FIG. 6 illustrates another embodiment that includes steps 100, 102, 104, 106, 116, and 118 and the further step of moving the one or more object items within the cavity with magnets, where the one or more object items include a magnetic material (step 122). In the embodiment of FIG. 6, a user might, e.g., manipulate magnets outside the interior space item to move one or more object items within the cavity.

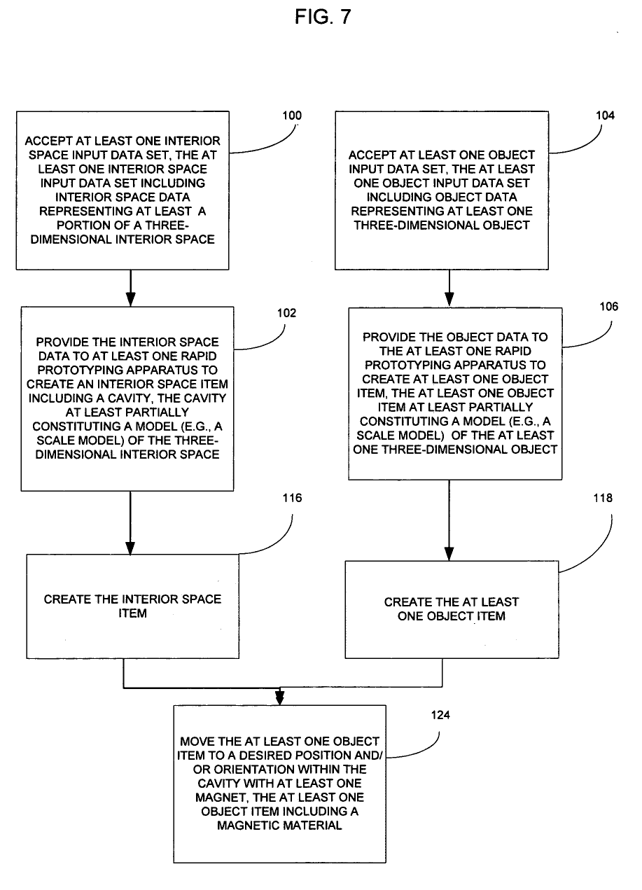

In FIG. 7, shown is an embodiment in which the one or more object items are moved to either a desired position or a desired orientation or both (step 124), in addition to the above-described steps 100, 102, 104, 106, 116 and 118. The embodiment pictured in FIG. 7 permits, e.g., a user to rotate the one or more object items as well as changing their positions within the cavity.

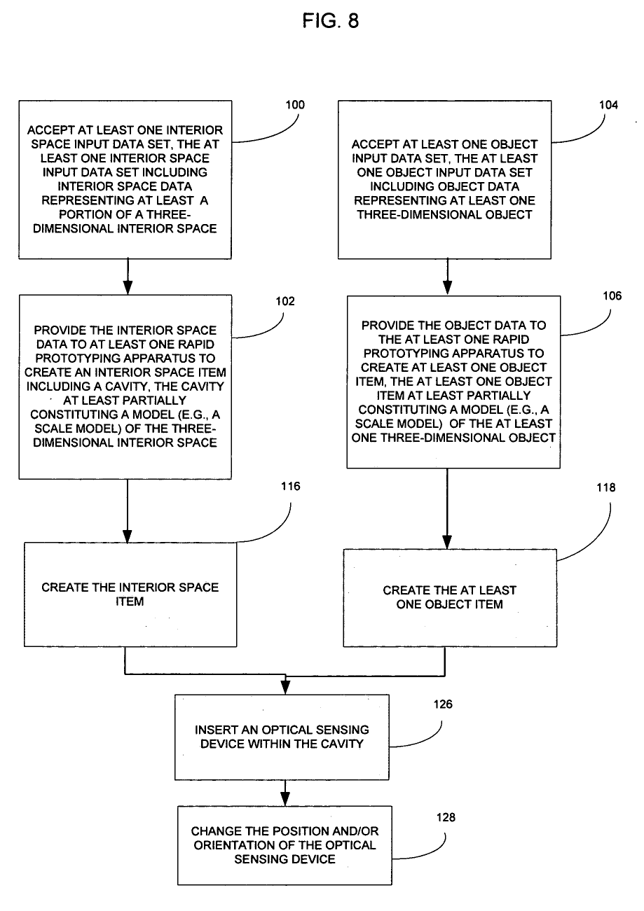

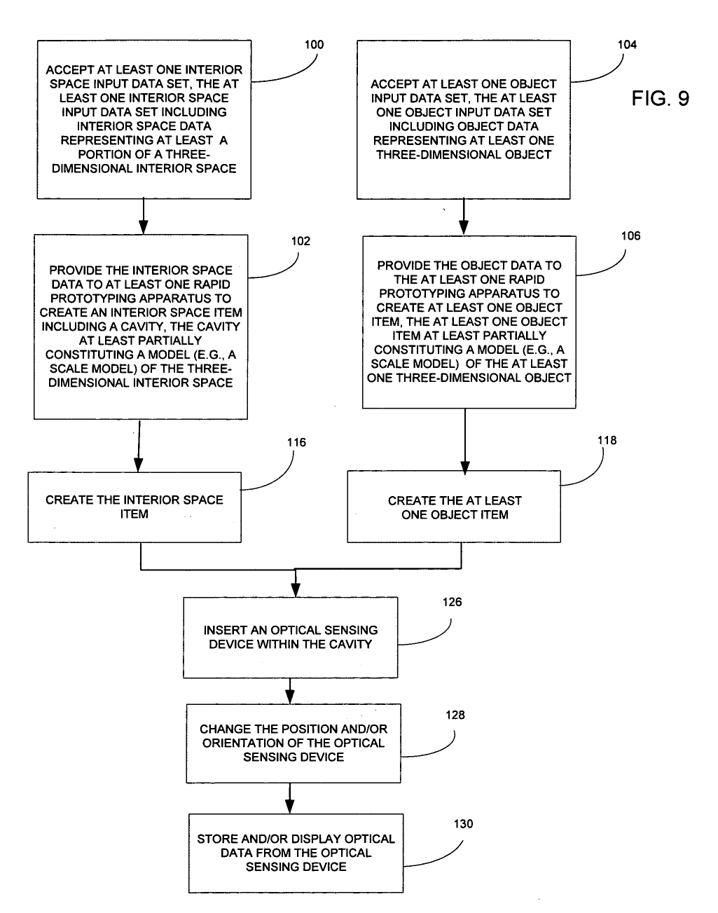

Another embodiment is shown in FIG. 8. Here, the embodiment includes inserting one or more optical sensing devices within the cavity (step 126) and changing a position and/or an orientation of the optical sensing device (step 128). Steps 126 and 128 are included in addition to steps 100, 102, 104, 106, 116 and 118 described above. The optical sensing device may be one of a wide variety of apparatuses, e.g., a digital camera, a film camera, or a fiber optic sensor. The optical sensing device may be manipulated from outside the cavity to change its position within the cavity and to point it in various directions through changes in orientation. The embodiment shown on FIG. 8 may permit, e.g., a user to visualize various arrangements of the one or more object items in the cavity as though she were in the interior space modeled by the cavity in the presence of the one or more objects modeled by the one or more object items. FIG. 9 additionally illustrates storing optical data from the optical sensing device, displaying optical data from the optical sensing device, or both (step 130). The optical data may be stored, for instance, on film or in a memory accessible to devices such as computers, or may displayed immediately or after a delay on display devices such as digital camera displays, computer screens, or television monitors.

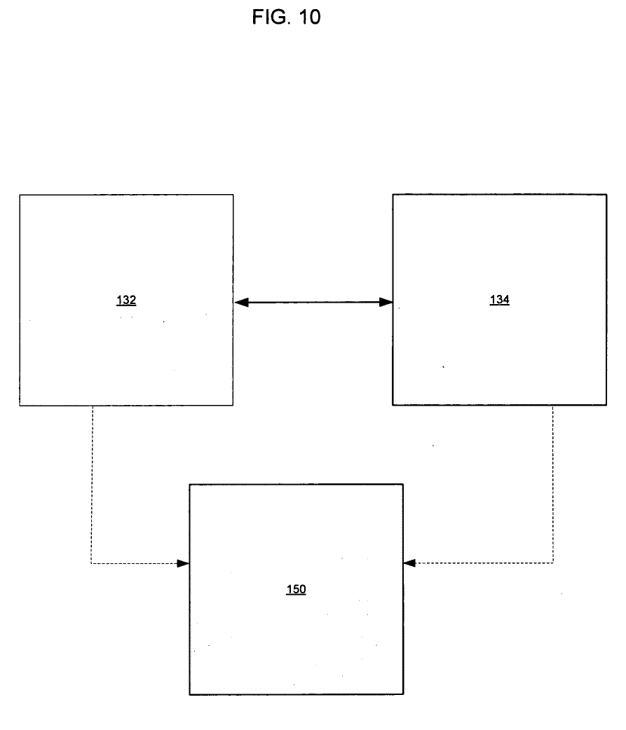

Another embodiment is shown in FIG. 10, a system for producing a model of an interior configuration of one or more three-dimensional objects within a three-dimensional space, the system including a processor 132; a memory 134 operably couplable to the processor 132; software stored in the memory and adapted to accept at least one interior space input data set, the at least one interior space input data set including interior space data representing at least the interior space, to provide the interior space data to at least one rapid prototyping apparatus to create an interior space item including a cavity, the cavity at least partially constituting a model of the three-dimensional interior space, to accept at least one object input data set, the at least one object input data set including object data representing at least the at least one three-dimensional object, and to provide the object data to the at least one rapid prototyping apparatus to create at least one object item, the at least one object item at least partially constituting a model of the at least one three-dimensional object; and rapid prototyping apparatus 150—operably couplable to processor 132 and/or a memory 134—that, among other things, actually physically constructs rapid prototyped items. Those skilled in the art will appreciate that constituent parts of rapid prototyping apparatus 140 vary widely, and that a few examples of such parts may include a rapid prototyping material reservoir, a rapid prototyping formation chamber, a rapid prototyping material injection device, a rapid prototyping extrusion device, a rapid prototyping molding device, a rapid prototyping heat device, a rapid prototyping light device, and/or a rapid prototyping pressure device. The rapid prototyping apparatus 140 may be consonant with commercial or patented techniques or methods known in the art. Examples of such prototypes, techniques, or methods are disclosed and incorporated herein by reference; U.S. Pat. Nos. 6,623,687, 5,684,713, 5,109,589, and 4,929,402, and U.S. patent application Nos. US 20020186216A1, and 20030218607A1. The system of FIG. 10 may be, e.g., a laptop or desktop computer with a graphic user interface, or a specially designed and constructed system.

FIG. 11 illustrates a method of providing an interior design service including providing the system shown in FIG. 10 to a user for use in interior design (step 136). The method of FIG. 11 may be, e.g., used by a business to provide interior design services to customers who seek an aid to visualization of various arrangements of objects within an interior space. Such a business might, for instance, rent all or part of the system of FIG. 10 and/or provide assistance in its use to customers.

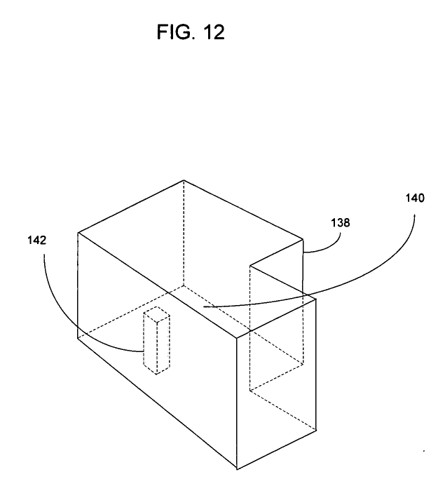

Still another embodiment, an article, is illustrated in FIG. 12. This embodiment includes an interior space item 138 including a cavity 140, the cavity 140 at least partially constituting a model of an interior space, the cavity 140 shaped by one or more rapid prototyping apparatuses according to interior space data representing at least a portion of the interior space; and one or more object items 142, the one or more object items 142 at least partially constituting models of one or more three-dimensional objects within the interior space, the one or more object items 142 shaped by one or more rapid prototyping apparatuses according to object data representing the one or more three-dimensional objects, and the one or more object items 142 at least partially resident within the cavity 140. The embodiment of FIG. 12 may, for instance, assist in visualization of various arrangements of objects within an interior space to the end of interior design for that interior space.

One skilled in the art will recognize that the foregoing components (e.g., steps), devices, and objects in FIGS. 1-12 and the discussion accompanying them are used as examples for the sake of conceptual clarity and that various configuration modifications are common. Consequently, as used herein, the specific exemplars set forth in FIGS. 1-12 and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will require optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firnware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter subject matter described herein are capable of being distributed as a program product in a variety of forms, and that an illustrative embodiment of the subject matter subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various embodiments described herein can be implemented, individually and/or collectively, by various types of electromechanical systems having a wide range of electrical components such as hardware, software, firmware, or virtually any combination thereof; and a wide range of components that may impart mechanical force or motion such as rigid bodies, spring or torsional bodies, hydraulics, and electro-magnetically actuated devices, or virtually any combination thereof. Consequently, as used herein “electro-mechanical system” includes, but is not limited to, electrical circuitry operably coupled with a transducer (e.g., an actuator, a motor, a piezoelectric crystal, etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), electrical circuitry forming a communications device (e.g., a modem, communications switch, or optical-electrical equipment), and any non-electrical analog thereto, such as optical or other analogs. Those skilled in the art will also appreciate that examples of electromechanical systems include but are not limited to a variety of consumer electronics systems, as well as other systems such as motorized transport systems, factory automation systems, security systems, and communication/computing systems. Those skilled in the art will recognize that electromechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and electrical circuitry forming a communications device (e.g., a modem, communications switch, or optical-electrical equipment).

All of the above U.S. patents, U.S. patent application publications, U.S. patent applications, foreign patents, foreign patent applications and non-patent publications referred to in this specification and/or listed in any Application Data Sheet, are incorporated herein by reference, in their entireties.

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality.

While particular aspects of the present subject matter described herein have been shown and described, it will be apparent to those skilled in the art that, based upon the teachings herein, changes and modifications may be made without departing from this subject matter described herein and its broader aspects and, therefore, the appended claims are to encompass within their scope all such changes and modifications as are within the true spirit and scope of this subject matter described herein. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

Other embodiments are within the following claims.

We claim:

1. A method for producing a model of an interior configuration of at least one three-dimensional object within a three-dimensional interior space, the method comprising:
accepting at least one interior space input data set, the at least one interior space input data set including interior space data representing at least a portion of the three-dimensional interior space;
providing the interior space data to at least one rapid prototyping apparatus to create an interior space item including a cavity, the cavity at least partially constituting a model of the three-dimensional interior space;
accepting at least one object input data set, the at least one object input data set including object data representing at least the at least one three-dimensional object; and
providing the object data to the at least one rapid prototyping apparatus to create at least one object item, the at least one object item at least partially constituting a model of the at least one three-dimensional object.

2. The method of claim 1, wherein the providing the object data to the at least one rapid prototyping apparatus to create the at least one object item is for creating the at least one object item within the cavity of the interior space item.

3. The method of claim 1, wherein
the providing the object data to the at least one rapid prototyping apparatus to create the at least one object item is for creating the at least one object item outside the cavity of the interior space item;
the providing the interior space data to the at least one rapid prototyping apparatus to create the interior space item is for creating the interior space item having an opening into the cavity dimensioned to allow insertion of the at least one object item into the cavity; and
further including inserting the at least one object item into the cavity through the opening.

4. The method of claim 1, further comprising:
creating the interior space item; and
creating the at least one object item.

5. The method of claim 4, further including moving the at least one object item within the cavity.

6. The method of claim 5, wherein the at least one object item includes a magnetic material, and wherein the moving the at least one object item is performed using at least one magnet.

7. The method of claim 6, wherein the moving the at least one object item within the cavity includes moving the at least one object item to a specified position within the cavity.

8. The method of claim 6, wherein the moving the at least one object item within the cavity includes moving the at least one object item to a specified orientation within the cavity.

9. The method of claim 4, further including:
inserting an optical sensing device within the cavity; and
changing at least one of a position or an orientation of the optical sensing device.

10. The method of claim 9, further including storing optical data from the optical sensing device.

11. The method of claim 9, further including displaying optical data from the optical sensing device.

12. A system for producing a model of an interior configuration of at least one three-dimensional object within a three-dimensional interior space, the system comprising:
a processor;
a memory operably couplable to the processor;
software stored in the memory and adapted
to accept at least one interior space input data set, the at least one interior space input data set including interior space data representing at least the interior space,
to accept at least one object input data set, the at least one object input data set including object data representing at least the at least one three-dimensional object,
to provide the interior space data to at least one rapid prototyping apparatus to create an interior space item including a cavity at least partially constituting a model of the three-dimensional interior space, and
to provide the object data to the at least one rapid prototyping apparatus to create at least one object item, the at least one object item at least partially constituting a model of the at least one three-dimensional object.

13. A method of providing an interior design service, the method comprising providing the system of claim 12, for use by a user.

14. The method of claim 13 wherein the providing includes assisting the user in the use of the system.

15. An article comprising:
an interior space item including a cavity, the cavity at least partially constituting a model of an interior space, the cavity shaped by at least one rapid prototyping apparatus according to interior space data representing at least a portion of the interior space; and
at least one object item, the at least one object item at least partially constituting a model of at least one three-dimensional object within the interior space, the at least one object item shaped by the at least one rapid prototyping apparatus according to object data representing the at least one three-dimensional object, the at least one object item at least partially resident within the cavity.

16. A method for producing a model of an interior configuration of at least one three-dimensional object within a three-dimensional interior space, the method comprising:
receiving interior space data for a rapid prototyping apparatus, the interior space data structured to create an interior space item including a cavity, the cavity at least partially constituting a model of the three-dimensional interior space; and
receiving object data for the rapid prototyping apparatus, the object data structured to create at least one object item, the at least one object item at least partially constituting a model of the at least one three-dimensional object.

17. A rapid prototyping system, the system comprising:
circuitry for receiving interior space data for a rapid prototyping apparatus, the interior space data structured to create an interior space item including a cavity, the cavity at least partially constituting a model of the three-dimensional interior space; and
circuitry for receiving object data for the rapid prototyping apparatus, the object data structured to create at least one object item, the at least one object item at least partially constituting a model of the at least one three-dimensional object.

18. The system of claim 17, further comprising:
the rapid prototyping apparatus including at least one of a rapid prototyping material reservoir, a rapid prototyping formation chamber, a rapid prototyping material injection device, a rapid prototyping extrusion device, a rapid prototyping molding device, a rapid prototyping heat device, a rapid prototyping light device, or a rapid prototyping pressure device; and
the rapid prototyping apparatus operably couplable with at least one of said circuitry for receiving interior space data for the rapid prototyping apparatus or said circuitry for receiving object data for the rapid prototyping apparatus.

19. The system of claim 17, wherein said circuitry for receiving interior space data for a rapid prototyping apparatus further comprises:
circuitry selected from an electrical-circuitry group including electrical circuitry having at least one discrete electrical circuit, electrical circuitry having at least one integrated circuit, electrical circuitry having at least one application specific integrated circuit, electrical circuitry having a general purpose computing device configured by a computer program, electrical circuitry having a memory device, or electrical circuitry having a communications device.

20. The system of claim 17, wherein said circuitry for receiving object data for the rapid prototyping apparatus further comprises:
circuitry selected from an electrical-circuitry group including electrical circuitry having at least one discrete electrical circuit, electrical circuitry having at least one integrated circuit, electrical circuitry having at least one application specific integrated circuit, electrical circuitry having a general purpose computing device configured by a computer program, electrical circuitry having a memory device, or electrical circuitry having a communications device.

21. The system of claim 17, wherein the model further comprises: at least one partially-to-scale model.

22. A system for use in design of a space, comprising:
computer storage media configured to store digital representations of items configured to fit within the space;
a user interface configured to receive user selections of one or more of the items;
a fabrication device operative to receive the digital representations of the user selected items and responsive to the received digital representations to produce three dimensional objects representative of the items;
a placement device configured to place the produced three dimensional objects in the space; and
an imaging system aligned to capture a representation of the space and the three dimensional items placed in the space.

23. The system of claim 22 further including a display responsive to the captured representation to present a representation of the space and the three dimensional items placed in the space.

24. The system of claim 22 wherein the fabrication device is a rapid prototyping device.

25. The system of claim 22 further including a transmission device operative to transmit data corresponding to the captured representation.

26. The system of claim 22 further including a 'storage device configured to store data corresponding to the captured representation.

27. The system of claim 22 wherein the imaging system is operative to capture a sequence of representations of the items placed in the space.

28. The system of claim 27 further including a storage device configured to store data sets, corresponding to the captured sequence of representation.

29. The system of claim 22 further including a moving device operative to change positions of the items placed in the space.

30. The system of claim 29 further including a user interface for receiving user position selections, the moving device is responsive to the user position selections to move the items to positions corresponding to the user position selections.

31. The system of claim 27 further including a storage device configured to store data sets, corresponding to the captured sequence of representation.

32. The system of claim 22 further including a moving device operative to change positions of the items placed in the space.
